(19) United States
(12) Patent Application Publication
(10) Pub. No.: US 2011/0087624 A1
(43) Pub. Date: Apr. 14, 2011

(54) System and Method for Generating Knowledge Based Radiological Report Information Via Ontology Driven Graphical User Interface

(75) Inventors: Charles R. Hale, Trumbull, CT (US); Donald E. Salz, New Rochelle, NY (US); Monowar Hossain, Stamford, CT (US); Tao Ye, Stamford, CT (US)

(73) Assignee: Fujifilm Medical Systems USA, Inc., Stamford, CT (US)

(21) Appl. No.: 12/897,357

(22) Filed: Oct. 4, 2010

Related U.S. Application Data
(63) Continuation-in-part of application No. 12/556,923, filed on Sep. 10, 2009.
Application No. 12/556,923 is a continuation-in-part of application No. 12/535,825, filed on Aug. 5, 2009.
Application No. 12/535,825 is a continuation-in-part of application No. 12/535,825, filed on Aug. 5, 2009.
(60) Provisional application No. 61/248,426, filed on Oct. 3, 2009.

(51) Int. Cl. G06N 5/02

(52) U.S. Cl. 706/11

(57) ABSTRACT

A system and method are provided to generate knowledge-based radiological report information via an ontology driven graphical user interface. Even further, a system and method are provided that employ radiological report domain ontology to specify and model a graphical user interface knowledge that is used by the present invention to create a graphical user interface and then to exercise the graphical user interface to generate knowledge-based radiological report information.

### CROSS REFERENCE TO RELATED APPLICATIONS

This application claims the benefit of U.S. Provisional Application No. 61/248,426, filed Oct. 3, 2009. This application is a continuation-in-part of U.S. patent application Ser. No. 12/556,923, filed Sep. 10, 2009, which is a continuation-in-part of U.S. patent application Ser. No. 12/535,825, filed Aug. 5, 2009. This application is also a continuation-in-part of U.S. patent application Ser. No. 12/535,825, filed Aug. 5, 2009.

### TECHNICAL FIELD

The present invention is directed in general to imaging technologies and more particularly to medical imaging and Picture Archiving and Communication Systems (PACS) having an image display and graphical user interface. A system and method are provided to present knowledge-based radiological information in a graphical user interface. Even further, a system and method are provided that employ radiological domain ontology to specify and model radiological information as knowledge. The modeled knowledge includes the knowledge of how to present the modeled radiological information in a graphical user interface. The graphical user interface knowledge is utilized by the present invention to create a graphical user interface, and then to exercise the graphical user interface to generate knowledge-based radiological report information.

### BACKGROUND OF THE INVENTION

In medical imaging, PACS are a combination of computers and/or networks dedicated to the storage, retrieval, presentation and distribution of images. While images may be stored in a variety of formats, the most common format for image storage is Digital Imaging and Communications in Medicine (DICOM). DICOM is a standard in which radiographic images and associated meta-data are communicated to the PACS system from imaging modalities for interaction by end-user medical personnel.

Medical personnel spend a significant amount of their time addressing administrative tasks. Such tasks include, for example, documenting patient interaction and treatment plans, preparing billing, reviewing lab results, reviewing radiological reports, recording observations and preparing reports for health insurance. Time spent on performing such tasks diminish the time available for patients and in some instances lead to inaccurate and hastily compiled reports or records when personnel are faced with the need to see multiple patients.

In order to address time deficiency issues, the current trend in the medical field is to automate as many health care related processes as possible by leveraging various technologies, and thereby freeing up personnel to spend more time with patients rather than performing administrative tasks. Another objective in this area is to ensure that administrative tasks are accomplished in an accurate and consistent manner. One approach to achieving this objective is to provide a standardized representation for health care related data and the system interface particularly within the various specialty areas, such as radiology, cardiology, etc.

Health care data is not easily reusable by disparate groups in the radiological field because it is stored with different methods and in different formats across a wide range of information technology. Various initiatives by groups and organizations across the globe, including the National Institutes of Health, Food and Drug Administration, and other medical bodies, have driven a set of standards for the consolidation of medical information into a common framework. One such standard is RadLex, which is a standard radiological lexicon proposed by the Radiological Society of North America, for uniform indexing and retrieval of radiology information. RadLex is a taxonomy having class hierarchies. It functions essentially as a dictionary of terms and the relationships among the terms. RadLex has some crucial limitations. The most significant of these limitations being the inability to support radiological findings and the relationships between findings and characteristics of the findings. What is needed is an extension to RadLex—an extension that provides domain specific modeling, which can then be applied to, or utilized by, a wide variety of applications such as report tools, presentation tools, treatment analysis programs, tools for the classification and verification of radiological information, and systems for improving radiological work flow. Such an extension would utilize an ontology that is domain specific in order to process radiological information.

Ontology is a data model for the modeling of concepts and the relationships between a set of concepts. Ontologies are utilized to illustrate the interaction between concepts and corresponding relationships within a specific domain of interest. Thus, concepts and the relationships between concepts can be represented in readable-text, wherein descriptions are provided to describe the concepts within a specific domain and the relationship axioms that constrain the interpretation of the domain specific concepts.

Numerous current products and research efforts offer tools that streamline data integration. These include centralized database projects such as the Functional Magnetic Resonance Imaging Data Center and the Protein Data Bank; distributed data collaboration networks such as the Biomedical Informatics Research Network; commercial tools for data organization, and systems for aggregating health care information such as Oracle Healthcare Transaction Base. In addition, tools have been developed to automatically validate data integrated into a common framework. Validation calls for techniques such as declarative interfaces between the ontology and the data source, and Bayesian reasoning to incorporate prior expert knowledge about the reliability of each source.

Automated data integration and validation require fewer human resources, but necessitates that data have well-defined a priori structure and meaning. The most successful approaches make use of a standardized master ontology that provides a framework to organize input data, as well as a technology scheme for augmenting and updating the existing ontology. This paradigm has been successfully applied in various ontologies including Biodynamic Ontology, Gene Ontology, the Mouse Gene Database, and the Mouse Gene projects, which provide a taxonomy of concepts and their attributes for annotating gene products. The Unified Medical Language System (UMLS) Metathesaurus and Semantic Network, combine multiple emerging standards to provide a standardized ontology of medical terms and their relationships.

Ontology is a philosophy of what exists. In computer science, ontology is used to model entities of the real world and the relations between them to create common dictionaries for their discussion. Basic concepts of ontology include (i) classes of instances/things, and (ii) relations between the classes, as described herein below. Ontology provides a vocabulary for talking about things that exist.

Relations, also referred to as properties, attributes and functions are specific associations of things with other things. Relations can include:
Relations between things that are part of each other, e.g., between a car and its tires;
Relations between things that are related through a process such as the process of creating the things, e.g., a painter and his/her painting; and
Relations between things and their measures, e.g., a tumorous mass and its size.

Some relations also associate things to fundamental concepts such as size, which would be related to large or small, or morphology which would be related to the shape of a mass such as round or linear.

Relations play a dual role in ontology. In one instance, individual things are referenced by way of properties, e.g., a person by a name or characteristic, or music by its title and composer. In another instance, knowledge being shared is often a property of things too. A thing can be specified by some of its properties, in order to query for the values of its other properties.

Not all relations are relevant to all things. It is convenient to discuss the domain of a relation as a “class” of things, also referred to as a category. Often domains of several relations may coincide.

There is flexibility in the granularity to which classes are defined. Assume automobile is a class. Ford cars may also be a class, with a restricted value of a brand property. However, this would only be a logical definition if Ford cars had attributes that were of interest or common to other automobiles. Generally, one can define classes as granular as an individual automobile unit, although one objective of ontology is to define classes that have important attributes.

There are a number of functionalities not provided by the systems described earlier. Accordingly, there is a need for a comprehensive system which is capable of enabling researchers to: i) efficiently enter heterogeneous local data into the framework of the UMLS-based ontology; ii) make necessary extensions to the standardized ontology to accommodate their local data; iii) validate the integrated data using expert rules and statistical models defined on data classes of the standardized ontology; iv) efficiently upgrade data that fails validation; and v) leverage the integrated data for menus, diagrams and directions. This is particularly the case in the field of radiology, and even more specifically within the various domains therein, such as mammography and the user interface systems for these environments.

To overcome some of the deficiencies earlier described, some existing systems have attempted to minimize the amount of effort that may be required to utilize and express radiological findings. However, these systems suffer from a myriad of drawbacks. Essentially these solutions have: a non-standard library or vocabulary; no error, terminology, or consistency checking, and no collaboration or tool that can be used by other application programs. Even more importantly, existing systems provide no tool or facility for utilizing or benefiting from domain specific knowledge, or providing an ontology driven graphical user interface.

The shortcomings of the prior art are overcome and additional advantages are provided through the provision of a method for utilizing ontology that is based upon data obtained from collections of unstructured and semi-structured knowledge sources that provide identification, validation and classification of radiological concepts to drive a graphical user interface.

The present invention addresses these needs as well as other needs.

### SUMMARY OF THE INVENTION

The present invention is directed in general to a system and method for generating knowledge-based radiological report information via an ontology driven graphical user interface. Even further, a method is programmed in a computing environment to utilize an ontology-driven graphical user interface to generate knowledge-based report information. The present invention provides a connection to a radiological domain ontology system to provide radiological graphical interface information both in context and out of context, along with an interface to at least one other system. On demand, constraint aware context sensitive and non-context sensitive menu items, diagrams, directions, suggestion and logic based on said radiological graphical interface information, are created and displayed for user interaction and selection. Specific knowledge-based radiological information associated with user selections is then reported.

For instance, one aspect of the present invention includes a method programmed in a computing environment for utilizing an ontology-driven graphical user interface to generate knowledge-based report information. The method comprises: providing a connection to a domain specific ontology system, the domain specific ontology system providing domain specific graphical interface information; providing an interface to at least one other system or application program; creating and displaying on demand, constraint aware context sensitive and non-context sensitive menu items, diagrams, directions, suggestion and logic based on the domain specific graphical interface information for user interaction and selection; and providing the knowledge-based report information associated with the user selections from the domain specific ontology system.

Another aspect of the present invention includes a system for specifying and modeling a graphical user interface for use in generating a knowledge-based radiological report. The system comprises an ontology server, an ontology based graphical user interface module, and a modeled ontology configured to model and specify radiological information as a first knowledge type. The first knowledge type comprising a second knowledge type including information specifying how to present the radiological information to the ontology based graphical user interface module. The ontology server is loaded with the modeled ontology. The ontology server is in operable communication with the ontology based graphical user interface module to receive requests for and provide graphical user interface information based on the second knowledge type information. The ontology based graphical user interface module is configured to display menus, diagrams and other information for selection by a user by employing the second knowledge type information for use in generating the knowledge-based radiological report. In addition, the ontology based graphical user interface module may be configured to capture a user selection and provide the user selection to the ontology server, wherein specific knowledge-based radiological information associated with the user selection is obtained from the ontology server and utilized to generate information for the knowledge-based radiological report.

In another aspect of the present invention, a method is programmed in a computing environment for providing one or more graphical user interface elements and returning user selections of the one or more graphical user interface elements to an application program, wherein the application program is operable to collect mammographic radiological information. The method comprises: utilizing an ontology server loaded with a modeled ontology, the modeled ontology modeling and specifying radiological information as a first knowledge base, the first knowledge base including a second knowledge base that defines the one or more graphical user interface elements and specifies how to present the one or more graphical user interface elements; utilizing an ontology based graphical user interface module; the ontology server is in operable communication with the ontology based graphical user interface module to receive a request for graphical user interface information for a finding; the ontology server employing the second knowledge base to provide relevant one or more graphical user interface elements relating to the finding, to the ontology based graphical user interface module. The ontology based graphical user interface module displays the received relevant one or more graphical user interface elements as objects for selection by a user by employing the specified presentation of the one or more graphical user interface elements. The ontology based graphical user interface module receives and utilizes a user selection of the relevant one or more graphical user interface elements relating to the finding to obtain knowledge based information from the modeled ontology for the selected interface elements and thereby return and display one or more finding characteristics applicable to said finding. Further, the finding and the one or more finding characteristics are provided to the application program.

### BRIEF DESCRIPTION OF THE DRAWINGS

The above-mentioned features and other features and advantages of this invention, and the manner of attaining them, will become apparent and be better understood by reference to the following description of the invention in conjunction with the accompanying drawing, wherein:

FIG. 1 is an illustrative block diagram of a radiological knowledge domain for which there are a plurality of attributes associated with findings;

FIG. 2 an illustrative diagram of instance of ontology concepts that represent a vocabulary for expressing the concepts of FIG. 1;

FIG. 3 is an exemplary data flow for utilizing the graphical user interface to consult the modeled ontology of the present invention;

FIG. 4 is an exemplary data flow for processing an application graphical user interface (GUI) request for information, by consulting the modeled ontology of the present invention; and

FIG. 5 is a block diagram generally illustrating a computing environment in which the present invention may be implemented.

### DETAILED DESCRIPTION OF THE INVENTION

This invention employs radiological domain ontology to specify and model radiological information as knowledge. Part of the knowledge that is modeled is the knowledge of how to present the modeled radiological knowledge in a graphical user interface. This graphical user interface knowledge is used by this invention to create a graphical user interface and then to exercise it to generate knowledge-based radiological report information. This invention utilizes the system described in U.S. patent application Ser. No. 12/556,923, filed Sep. 10, 2009, entitled “System and Method for Processing Radiological Information Utilizing Radiological Domain Ontology.”

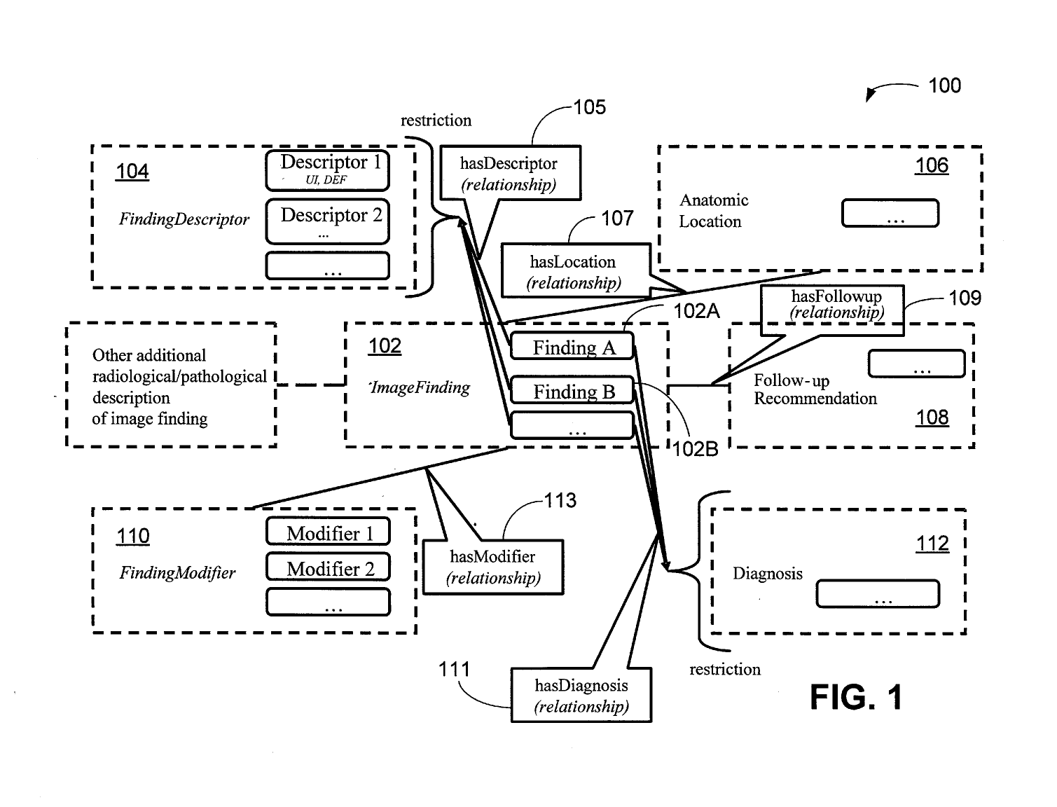

Referring initially to FIG. 1, pathological, physiological and iatrogenic entities and pathological, physiological and iatrogenic observations may be modeled conceptually as radiological findings. Therefore, in connection with a particular image that is being observed or considered by a radiologist, there may be a number of findings 102A, 102B collectively referenced as findings 102. Associated with the findings 102 are a number of finding descriptors 104. A relationship expressed as an object property—“hasDescriptor” 105 is provided for the relevant findings 102.

Attributes within the realm of radiological knowledge including diagnosis, anatomic location, and follow-up recommendation, of pathological, physiological, and iatrogenic entities and pathological, physiological, and iatrogenic observations may be modeled conceptually as radiological finding characteristics. As such, a particular one of the findings 102 may be associated with an anatomic location 106. The anatomic location 106 would be a finding characteristic with a relationship—“hasLocation” 107 and an object property. Further, there may be a follow-up recommendation 108 for any one or more of the findings, which would result in a relationship—“hasFollowup” 109. Even further, findings 102 may also be associated with a diagnosis 112 having a restrictive relationship—“hasDiagnosis” 111. Further still, there may also be finding modifiers 110, with resulting relationship—“hasModifier” 113. The relationships between pathological, physiological, and iatrogenic entities/observations and radiological finding characteristics may therefore be modeled as object properties, i.e. “hasLocation” 107; “hasFollowup” 109; “hasDiagnosis” 111 and “hasModifier” 113.

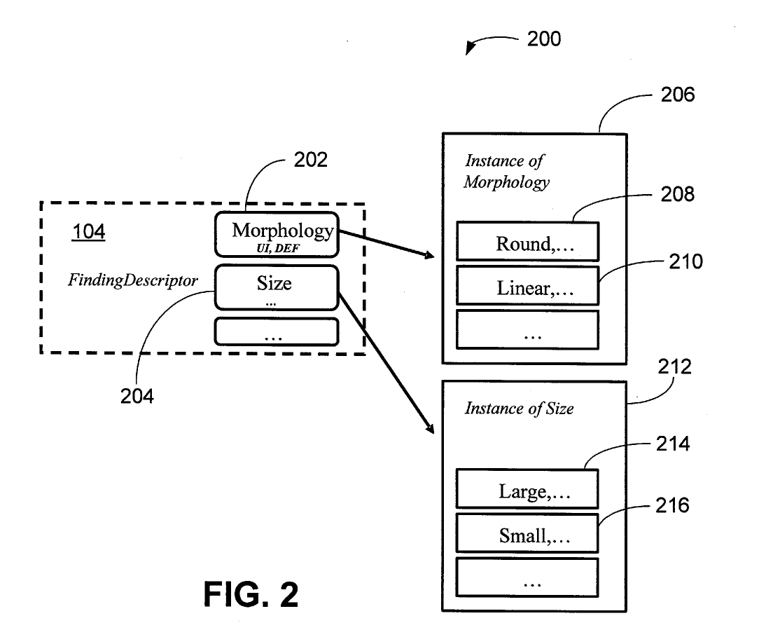

The modeled ontology may further contain constraints on radiological findings, radiological finding characteristics, and relationships. Further still, the ontology may also contain concept properties, such as applicability to a user interface or application localization, i.e., language indication. It should be understood that certain concepts may be defining concepts from which individual instances may be utilized to represent the vocabulary representing the concept. This aspect is best illustrated with reference to FIG. 2.

As shown in FIGS. 1 and 2, finding descriptor 104 may include the concept of morphology 202, and size 204. Any of these concepts may be a defining concept from which an instance may be derived to further represent or further describe a finding or finding characteristic. As illustrated, morphology 202 may have a morphology instance 206, characterized by further descriptions or qualifiers such as round 208, linear 210 and so forth. Similarly, size 204 may have a size instance 212 characterized by further descriptions or qualifiers such as Large 214, small 216, etc.

These concept instances can be utilized as the vocabulary for describing finding 102. Even further, the concept instances 206, 212 provide a vocabulary guide in the sense that a radiologist can select only one of the provided descriptions 208, 210, 214, 216 from within each of the relevant instances, e.g., round or linear in the case of morphology. For example, only one (round 208 or linear 210) can be selected in the case of morphology instance 206. As such, an individual radiologist or system utilizing the ontology cannot describe a mass, for example, as being both linear 210 and round 208; or the size of a mass as being both large 212 and small 214. The system thereby incorporates error, terminology and consistency checking. In a further embodiment of the present invention, the vocabulary guide allows a selection of more than one described invention, wherein the number of allowable selections is governed by the cardinality of the relationship between the finding and the relevant characteristic. Accordingly, the previously described concept instances 206, 212 provide a cardinality of “max 1.”

In order to facilitate reference and identification of the parts of an image for the purpose of diagnosis or analysis of the subject, the various parts of the image may need to be identified and commented or reported upon. The present invention provides a system and method for consulting the radiological domain ontology earlier described, for presenting a graphical user interface.

One element of the invention includes a connection to a radiological domain ontology system that both declares and fulfills a model of radiological domain knowledge. The ontological system will be consulted for the following:

Radiological graphical user interface information both in context and out of context as follows:
Pathological, physiological, and iatrogenic entities and pathological, physiological, and iatrogenic observations modeled conceptually as radiological findings as illustrated in FIG. 1.
Attributes, including diagnosis, anatomic location, and follow-up recommendation, of pathological, physiological, and iatrogenic entities, and pathological, physiological, and iatrogenic observations modeled conceptually as radiological finding characteristics also illustrated in FIG. 1.
Constraints on radiological findings, radiological finding characteristics and relationships.
Individuals (instances) of ontology concepts as shown in FIG. 2 that represent the vocabulary for expressing the concept.

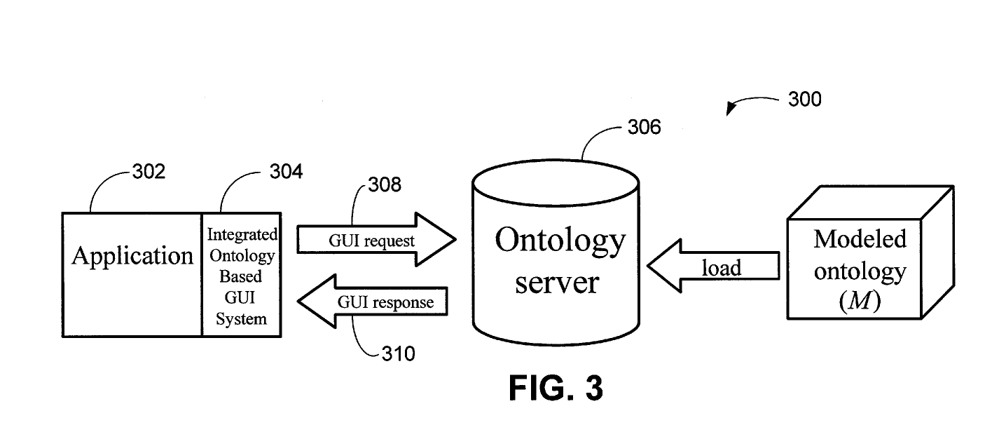

Having described the framework for the present invention, attention is directed next to the operational aspects of the present invention. As previously described, the present invention may be employed by other applications to present a graphical user interface and support user interactions. Turning to the block diagram 300 of FIG. 3, there is an illustration of an application program 302 that includes an ontology based GUI system 304 of the present invention. Also shown is an ontology server 306 and a modeled ontology M. In operation, the ontology based GUI system 304 is integrated into the application program 302 such that collaboration and exchange of information between the two are seamless to both the end user and ontology server 306. The ontology server 306 is loaded with the modeled ontology M of the present invention. The modeled ontology M provides the knowledge information for a radiological GUI interface. GUI request 308 is made through the ontology based GUI system 304 for information contained within the modeled ontology M. A response 310 is provided back to the GUI system 304. The response 310 includes the information necessary to build and present the GUI including menus, items, diagrams, instructions and logic.

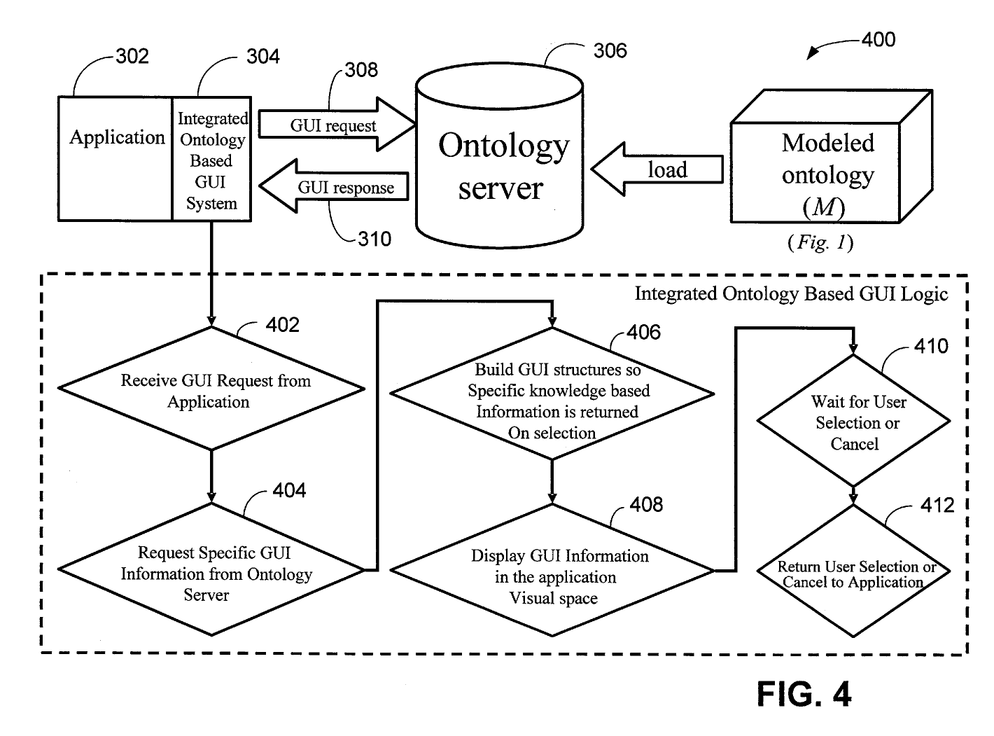

The specific logic within the ontology based GUI system 304 is best described with reference to an exemplary data flow 400 in FIG. 4. The data flow 400 illustrates the processing of an application graphical user interface (GUI) request for information by consulting the modeled ontology of the present invention. In operation, the ontology based GUI system 304 receives a GUI request from the application program 302, at step 402. Next, at step 404, specific GUI information is requested from the ontology server 306, which was previously loaded with the modeled ontology M. Utilizing the information obtained from the ontology server 306, a GUI structure is built at step 406. More specifically, there is an on demand creation and display of constraint aware context sensitive and non-context sensitive menus, diagrams, directions, suggestions and logic based on the radiological graphical interface information acquired from the loaded ontology server 306. The GUI structure is built to cause specific knowledge based information to be returned in response to an end user selection. At step 408, the GUI information is displayed within the application's visual space. At this point there is a delay, in anticipation of end user interaction with the constraint aware context sensitive and non-context sensitive menus, diagrams, directions, suggestions and logic, at step 410. An end user may make a selection to continue the initiated process or cancel the operation. In either case, the end user action is returned to the application program 302, at step 412. The application program may then respond as it would with any other user interface indicia.

To further illustrate the present invention, an application of the various features and aspects of the invention is next described. In this implementation example, a radiological ontology for mammography is utilized.

The first thing this invention does is connect to the ontology system. The second thing this invention does is provide a system and method that allows for this invention to be used by other systems in the manner described herein.

The following example will illustrate how the invention may be used. First, an application program with a purpose of collecting mammographic radiological information, integrates this invention into its application space. Using the system and method described herein, the application program directs the system to display the base level graphical user interface (GUI) elements and returns the user's selection. For the purposes of this example, assume the user selects “findings” as the next level of GUI interest. Using the system and method described herein, the application program then directs the system to display the findings GUI and to return the end user's selection. For the purposes of this example, assume the user selects to enable the presentation of menu choices that are relevant to “mass.” The ontology server will return just the knowledge-based informational items that are related to the ontological model for a “mass.” Further, the application program directs the system to display the GUI in the context of “mass” and to capture/return the user's selection or selections. In other words, the application program provides a display of the characteristics that can be applied to a mass and allow the user to select one or more of the characteristics. The user's selection results in a return of the relevant knowledge-based information to the initiating application process. The application then has the knowledge-based radiological information for a mass and its chosen characteristics.

The present invention provides a useful, novel and non-obvious means to utilize radiological report domain ontology to validate, identify and classify radiological information to provide content information for a graphical user interface. In other words, it provides means to determine what informational items are allowable and/or belong in a graphical user interface and how to best present and interact with them.

Additionally, the present invention provides a tool that may be utilized by other applications or systems as a building block for further information processing.

Having described the system and method of the present invention and an embodiment thereof, an exemplary computer environment for implementing the described design and execution is presented next.

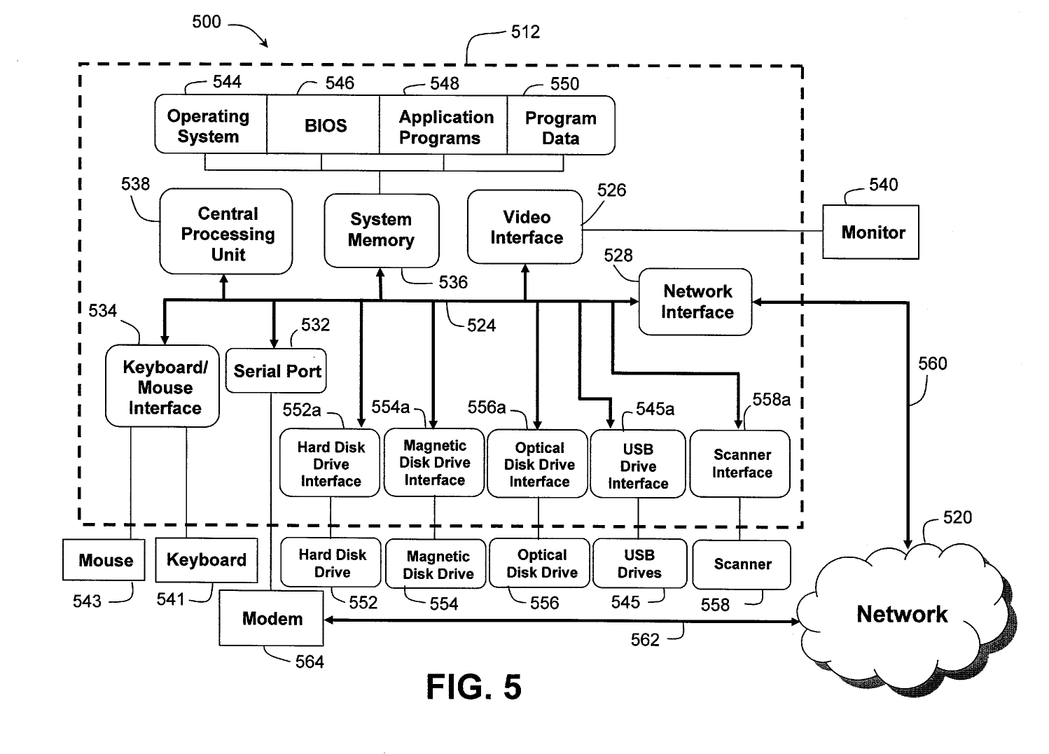

FIG. 5 illustrates an exemplary computing environment 500 that can be used to implement any of the processing thus far described. Computer 512 may be a personal computer including a system bus 524 that couples a video interface 526, network interface 528, one or more serial ports 532, a keyboard/mouse interface 534, and a system memory 536 to a Central Processing Unit (CPU) 538. Computer 512 may also include a Graphics Processing Unit (GPU) or one or more other special or general purpose processing units. A monitor or display 540 is connected to bus 524 by video interface 526 and provides the user with a graphical user interface to view, edit, and otherwise manipulate digital images. The graphical user interface allows the user to enter commands and information into computer 512 using a keyboard 541 and a user interface selection device 543, such as a mouse or other pointing device. Keyboard 541 and user interface selection device are connected to bus 524 through keyboard/mouse interface 534. The display 540 and user interface selection device 543 are used in combination to form the graphical user interface which allows the user to implement at least a portion of the present invention. Other peripheral devices may be connected to computer 512 through serial port 532 or universal serial bus (USB) drives 545 to transfer information to and from computer 512. For example, CT scanners, X-ray devices and the like may be connected to computer 512 through serial port 532 or USB drives 545 so that data representative of a digitally represented still image or video may be downloaded to system memory 536 or another memory storage device associated with computer 512 to enable processes and functions in accordance with the present invention.

The system memory 536 is also connected to bus 524 and may include read only memory (ROM), random access memory (RAM), an operating system 544, a basic input/output system (BIOS) 546, application programs 548 and program data. The computer 512 may further include a solid state drive (SSD), hard disk drive 552 for reading from and writing to a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media card), and a scanner 558 for scanning items such as still image photographs to be downloaded to computer 512. A hard disk drive interface 552a, magnetic disk drive interface 554a, an optical drive interface 556a, a USB drive interface 545a, and a scanner interface 558a operate to connect bus 524 to hard disk drive 552, magnetic disk drive 554, optical disk drive 556, USB drive 545 and a scanner 558, respectively. Each of these drive components and their associated computer-readable media may provide computer 512 with non-volatile storage of computer-readable instruction, program modules, data structures, application programs, an operating system, and other data for the computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with image capture devices such as MRI, CT scanners, Ultrasound, Positron Emission Tomography (PET) or X-Ray devices. Network interface 528 provides a communication path 560 between bus 524 and network 520, which allows images to be communicated through network 520 from any of the previously identified imaging devices, and optionally saved in a memory, to the computer 512. This type of logical network connection is commonly used in conjunction with a local area network. Images may also be communicated from bus 524 through a communication path 562 to network 520 using serial port 532 and a modem 564. Using a modem connection between the computer 512 and imaging devices may be used in conjunction with a wide area network or the internet. It will be appreciated that the network connections shown herein are merely exemplary, and it is within the scope of the present invention to use other types of network connections between computer 512 and imaging devices including both wired and wireless connections.

From the foregoing, it will be seen that this invention is one well adapted to attain all the ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed, as the best mode contemplated for carrying out this invention, but that the invention will include all embodiments falling within the scope and spirit of the appended claims.

What is claimed is:

1. A method programmed in a computing environment for utilizing an ontology-driven graphical user interface to generate knowledge-based report information, the method comprising:
providing a connection to a domain specific ontology system, said domain specific ontology system providing domain specific graphical interface information;
providing an interface to at least one other system or application program;
creating and displaying on demand, constraint aware context sensitive and non-context sensitive menu items, diagrams, directions, suggestion and logic based on said domain specific graphical interface information for user interaction and selection; and
providing the knowledge-based report information associated with said user selections from said domain specific ontology system.

2. A method in accordance with claim 1, wherein said domain is radiological.

3. A method in accordance with claim 2 further comprising:
employing said radiological domain ontology system to specify and model the ontology-driven graphical user interface to create a graphical user interface having objects relevant to radiology; and
utilizing said graphical user interface object to generate knowledge-based radiological report information.

4. A system for specifying and modeling a graphical user interface for use in generating a knowledge-based radiological report, the system comprising:
an ontology server;
an ontology based graphical user interface module; and
a modeled ontology configured to model and specify radiological information as a first knowledge type, said first knowledge type including a second knowledge type, said second knowledge type including information that specifies how to present said radiological information to said ontology based graphical user interface module,
wherein said ontology server is loaded with said modeled ontology, said ontology server in operable communication with said ontology based graphical user interface module to receive requests for and provide graphical user interface information based on said second knowledge type information, and
wherein said ontology based graphical user interface module is configured to display menus, diagrams and other information for selection by a user, by employing said second knowledge type information to generate the knowledge-based radiological report.

5. The system of claim 4 wherein said ontology based graphical user interface module is configured to capture a user selection and provide said user selection to said ontology server, and
wherein specific knowledge-based radiological information associated with said user selection is obtained from said ontology server and utilized to generate information for the knowledge-based radiological report.

6. A method programmed in a computing environment for providing one or more graphical user interface elements and returning user selections of the one or more graphical user interface elements to an application program, wherein the application program is operable to collect mammographic radiological information, the method comprising:
utilizing an ontology server loaded with a modeled ontology, said modeled ontology modeling and specifying radiological information as a first knowledge base, said first knowledge base including a second knowledge base that defines the one or more graphical user interface elements and specifies how to present the one or more graphical user interface elements;
utilizing an ontology based graphical user interface module;
said ontology server in operable communication with said ontology based graphical user interface module to receive a request for graphical user interface information for a finding;
said ontology server employing said second knowledge base to provide relevant ones of said one or more graphical user interface elements relating to said finding, to said ontology based graphical user interface module,
wherein said ontology based graphical user interface module displays the received relevant ones of said one or more graphical user interface elements as objects for selection by a user, by employing said specification of how to present the one or more graphical user interface elements,
wherein said ontology based graphical user interface module receives and utilizes a user selection of said relevant ones of said one or more graphical user interface elements relating to said finding, to obtain knowledge based information from said modeled ontology for the selected interface elements and thereby return and display one or more finding characteristics applicable to said finding, and
wherein said finding and said one or more finding characteristics are provided to the application program.
